(19) United States
(12) Patent Application Publication
(10) Pub. No.: US 2019/0381692 A1
(43) Pub. Date: Dec. 19, 2019

(54) Mesophase carbon objects, compositions and manufacturing processes

(71) Applicant: MotorCarbon LLC, Isle of Palms, SC (US)

(72) Inventor: Nicholas James Johannes, Mt. Pleasant, SC (US)

(73) Assignee: MotorCarbon LLC, Isle of Palms, SC (US)

(21) Appl. No.: 16/440,812

(22) Filed: Jun. 13, 2019

Related U.S. Application Data
(60) Provisional application No. 62/684,606, filed on Jun. 13, 2018.

(51) Int. Cl. B28B 1/00; B33Y 10/00; B33Y 30/00

(52) U.S. Cl. CPC B28B 1/001; B33Y 30/00; B33Y 10/00

(57) ABSTRACT

Carbon powders are homogeneous powders derived from mesophase pitch. Additive Manufacturing (AM) use these powders in two basic classes of AM to produce manufactured articles: 1) Low temperature 3D printers suitable for plastics, polymers, binders and resins, and 2) High temperature 3D printers suitable for direct 3D metal-fusion printing. There are three categories of carbon powders used for AM: a) Powders derived directly from mesophase carbon pitches with a low melting point. These powders can be printed, without binders; b) Carbon powders, that blend with polymers, binders or resins of similar melting temperatures; and c) Carbon powders that have been graphitized and/or carbonized, that can sustain their form above 3000 ° C. and are compounded with metal or ceramic matrix powders, which can be printed in high temperature environment 3D printers.

### STATEMENT REGARDING FEDERALLY SPONSORED RESEARCH OR DEVELOPMENT

Not applicable

### BACKGROUND OF THE EMBODIMENTS

### Field of the Embodiments

The general field of the embodiments of the Mesophase Carbon Manufacturing Process is Additive Manufacturing (AM). The term AM encompasses many technologies including subsets like 3D Printing, Rapid Prototyping, Direct Digital Manufacturing, Layered Manufacturing and Additive Fabrication.

### Description of Prior Art

The prior art teaches integrated evaporation, heat treating and oxidizing process for transforming selected pitches into 3D shapes, sinterable powders and reinforcements, capable of being processed into cohesive net shape objects.

### SUMMARY OF THE EMBODIMENTS

Embodiments of the embodiments of the Mesophase Carbon Objects, Compositions and Manufacturing Processes 100 comprise processes that use carbon powders to manufacture net shape carbon objects by way of Additive Manufacturing (AM) using carbon mesophase powders, graphite powders, carbon-carbon powders or carbon powders with binders or resins. Carbon powders are homogeneous, spherical powders, which are derived from either petroleum or coal tar mesophase pitches or made by synthetic mesophase pitches derived from naphthalene or polyacrylonitrile.

In principal, many very thin layers of material are individually layered or stacked until the object grows into its net shape. A heat beam, which exactly follows the part's layered design, melts or cures the exposed material particles and fuses them together, thereby creating a solid object, layer by layer.

There are many design variations of 3D printers 101, from simple, low temperature polymer printers and resin-added printers to high temperature metal-sintering printers. They all have the same principle of melt-fusing thin layers of material particles into solid objects.

In its beginning, AM was known as Rapid Prototyping, mainly for producing pre-production visualization models and simple prototypes made of polymers of various sophistication. Today, AM applications have moved to mass production such as precision parts made of polymers with high temperature resins approaching 300° C. Intricate metal/ceramic matrix objects are fabricated for the mass produced end-use in jet engines, satellites, aircraft, automobiles, weapons, machines, dental restorations, medical implants and even sporting goods.

The most important advantage of AM is the ability to produce complex, sophisticated objects, which cannot be produced by common production methods, such as casting and machining. Point in case is a titanium jet engine turbine blade with a network of intricate internal cooling channels. These channels inside the thin-walled blade prevent it from melting. Such advanced parts can only be made by AM.

These carbon powders can be unalloyed, or a hybrid matrix with metals, ceramics, silica, alumina, oxides, graphite, graphene etc., synthesized by way of powder metallurgy (P/M). These carbon powders (optionally carbon-carbon or graphite or mesophase carbon) can be reinforced by using stabilizers, such as nanotubes, short fibers of various materials, whiskers, microbeads and micro spheres, graphene, etc.

Carbon powders can be loose, in dry beds, as spray powders, or in pellet form, or formed with binders into feeder sticks or reeled filament strands. Most all AM techniques can be customized to process said carbon powders, such as SLS, SLA, FDM, FDM, SLM, DMLS, EBM, PBF, SPJ, 3DP, MGM etc. using either a print head, or a spray, laser, or an electron/microwave/plasma beam/ultraviolet, or coherent polarization beam, or spectral beam combining etc. to place, then melt, fuse, bond and/or sinter these powders.

The embodiments employ three general categories of mesophase carbon powders and graphite powders used for AM 3D printing:

1. Mesophase carbon comminuted directly into carbon powders with a softening point between around 220-400° C. and with a mesophase content between 55% and 99%. These powders can be printed, without additional binders. After these carbon objects have been AM 3D printed, it is possible to carbonize and/or graphitize these objects, whereby the residual pitch evaporates or cokes.

2. Mesophase carbon powders, that have a mesophase content up to 99% with a softening point between around 200-400° C. are suitable to be AM printed using binders or resins synthesized with various polymers such as ABS, Nylon or PEEK, which may have similar softening or melting temperatures.

3. Carbon powders have been carbonized and/or graphitized, can sustain their molecular form above 3000° C. and are actually unmeltable. Therefore, these lightweight powders can be compounded or synthesized with most varieties of metal powders and/or ceramic powders with very high melting temperatures, to produce novel material matrix alloys with a large variety of modelled material characteristics.

In some embodiments, 3D metal printers combine binders or resins 201 with metal powders 202. After the metal objects have been 3D printed at low temperatures, they are then sintered, whereby the binder evaporates, leaving the pure metal/ceramic object.

There has thus been outlined the more important features of the embodiments in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a schematic view of an extruder printhead.

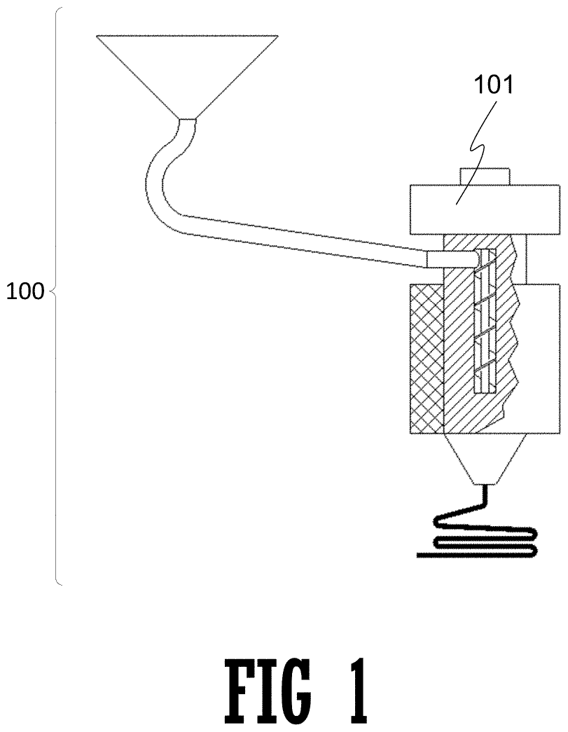

FIG. 2 is a schematic view of a filament feeder.

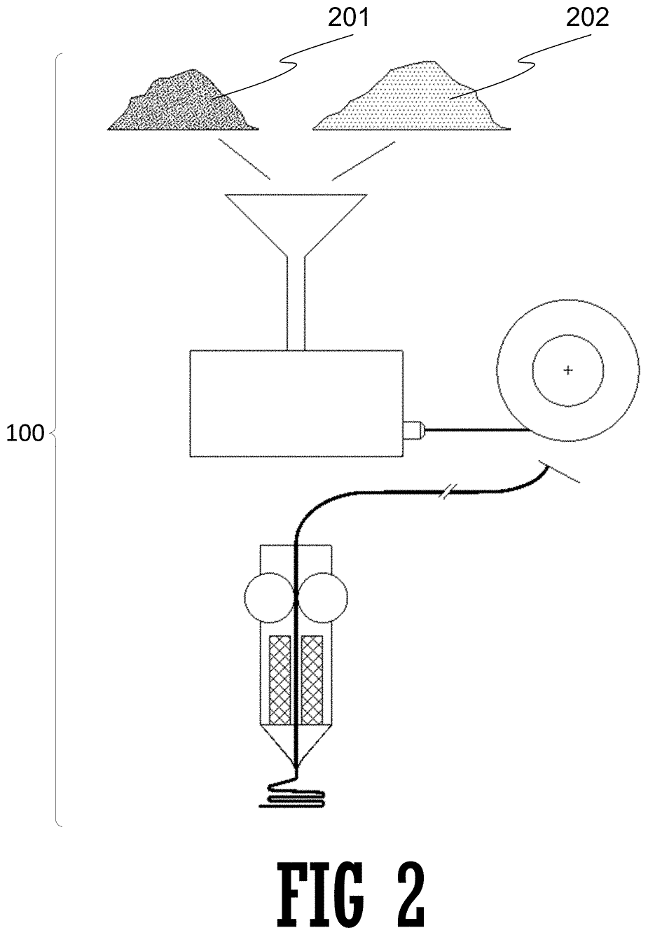

FIG. 3 is a schematic view of a stereolithography using liquid resin or metal powders.

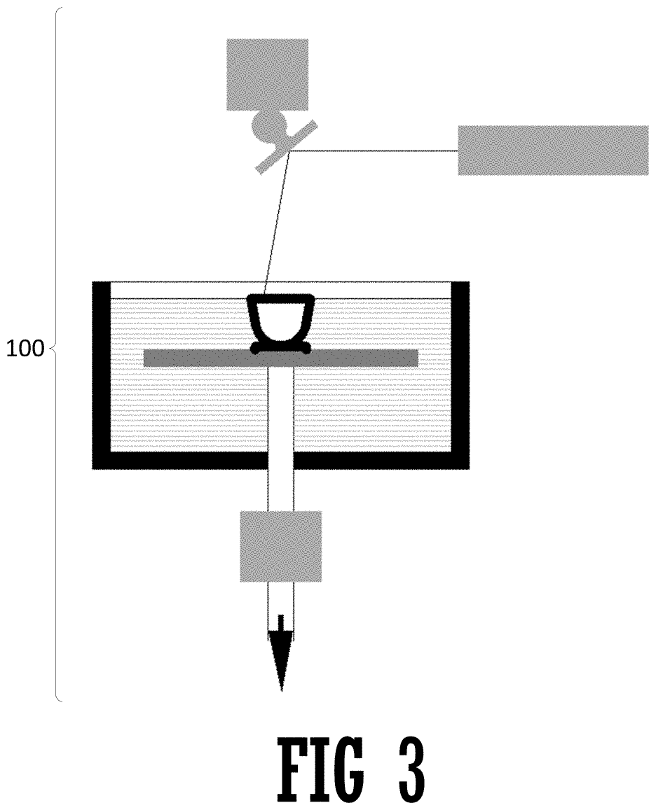

### DETAILED DESCRIPTION OF THE PREFERRED EMBODIMENTS

Petroleum Pitch

For any mass-manufactured object to be produced economically, the raw material must be available in abundance and easily converted to a net shape. The least expensive metal and polymer components, for example, are castings, forgings and injection molded thermoplastics, which can achieve high production rates. There are however limitations to the complexity of these formed objects. In contrast, the embodiments comprising Additive Manufacturing produces complex, intricate, and thin-walled hollow objects, which cannot be made by any other production method. Objects made by AM use either loose or compacted powders, or pellets or thermoplastics and provides a net shape manufacturing alternative.

Embodiments of the Mesophase Carbon Manufacturing Process comprise production of net shaped carbon, graphite, carbon-carbon or carbon-hybrid objects, which have a wide variety of potential applications in the defense and commercial sectors. Additional embodiments comprise the production of highly complex, intricate shaped parts made from carbon, carbon-polymers, carbon-carbon, carbon-ceramics or carbon-metal hybrids, or a combination thereof, that enable these materials to be used where carbon was formerly precluded by its high materials and manufacturing costs, or impossible to be produced any other way.

Embodiments of the Mesophase Carbon Manufacturing Process comprise Additive Manufacturing (AM) reaction bonding, melting, fusing, or sintering of stabilized mesophase or graphitized powders (carbon powders) derived from hydrocarbons in petroleum pitch or coal tar pitch, or from synthetic Naphthalene or polyacrylonitrile (PAN) or a combination thereof. These carbon powders can be mixed with a wide variety of materials to form a hybrid matrix. In some embodiments, carbon powders can be unalloyed, or combined with polymers, resins and binders, or can be a hybrid matrix including one or more additional material including metals, ceramics, silica, alumina, and oxides by way of mixing or synthesis, common in powder metallurgy.

The embodiments of the Mesophase Carbon Manufacturing Process comprise manufacturing methods for producing highly complex, net shape objects made of mesophase carbon, carbon-resin and carbon polymer composites; as well as hybrids of graphite-metals and graphite-ceramics, which are synthesized by way of powder metallurgy. These carbon hybrid powders, processed into net shapes by AM methods present novel 3D-printable materials, which allow complex shapes, thereby dramatically reduce weight and enhance thermal stability. These powder-processed materials can incorporate reinforcements materials including nanotubes, microspheres, whiskers, short fibers, microbeads, and graphene.

One embodiment is comprised of the production of carbon-carbon materials for aircraft brakes. Carbon-carbon reinforced composites exhibit similar thermal stability to graphite but possess higher mechanical properties. Once carbonized, 3D printed carbon objects are in turn graphitized and exhibit the highest thermal conductivity of any manmade material, with a low coefficient of thermal expansion of less than about 15 x 10-6 reciprocal degrees Centigrade.

Mesophase Carbon Pitch Technology

In an embodiment is comprised of mesophase pitches in powder form either those derived from hydrocarbons in coal tar pitch or petroleum pitch, or those from synthetic mesophase pitches derived from naphthalene or polyacrylonitrile (PAN), or a combination thereof. Coal tar pitch is not ideal, because its production involves intense heat (1100° C.), which destroys the aromatic hydrocarbon compounds, some of which are valuable to carbon powders.

Embodiment are comprised of petroleum-derived mesophase with physical properties of petroleum-derived mesophase similar to synthetic mesophase pitch derived from naphthalene such as Mitsubishi AR. The processing and cost of the petroleum mesophase pitch precursor enables it to be priced much less than the AR or PAN. Naphthalene-derived mesophase pitches and PAN are very expensive and difficult to control the melt under atmospheric oxygen condition; therefore, mesophase pitch derived from petroleum is the most preferred.

Petroleum and coal hydrocarbons are an abundant raw material. Yet carbon as such can neither be melted nor sintered in the conventional sense, and thus net shape processing is problematic. Embodiments are comprised of pitches and mixtures of polycyclic aromatic hydrocarbons that are thermoplastic and, depending on the hydrogen mole fraction, can be melted, thus, 3D printed (AM) to net shape. The conversion of the pitches to solid carbon requires the diffusion of large amounts of hydrogen and alkanes from the interior of a solid body. For instance, powdered coke, fused with a tar binder, is commonly used to make graphite electrodes. Tar significantly increases the effective char yield, but the outgassing creates substantial shrinkage and material cracking, rendering it unsuitable for net shape parts manufacturing.

However, ungraphitized mesophase carbon pitch has a low softening point between 220°-400° C., and therefore can be AM processed at much lower temperatures than graphitized mesophase powders composites.

In a preferred embodiment that is comprised of a starting material that is a lower softening point pitch derived from residues of cracked crude oil. This is distilled into petroleum pitch with a high carbon content (55%-100%) and well-known properties and affordability; other grades can be substituted or combined. High carbon content in pitch is particularly useful because carbon content of around 80 percent or above saves evaporation requirements.

The process comprises pressurized heat treating the pitch as necessary to provide a petroleum pitch having a carbon value of at least about 50 and preferably above 65, as measured by ASTM D2416 and a softening point of at least 100° C. and preferably above 120° C.

The preferred step thereafter is to heat treat said pitch at about 200-750° C. for about 0.01-8 hours; and/or oxidize said pitch at about 300-1200° C. for about 0.1-20 hours, to produce a carbon composition into mesophase.

During this heat treatment, this isotropic pitch becomes highly anisotropic mesophase pitch, which depending on process time, measures between 65-98 weight percent carbon in the Conradson test. Mesophase pitch can also be derived directly from petroleum pitch in a process used to prepare the precursor to manufacture high modulus pitch fibers. The heat treated pitch provides the effect of partial anisotropy of the pitch and the sinterability and ultimately on the desired carbon properties for additive manufacturing, having a higher softening point than said pitch of around 200-450° C.; and thereafter to solidify as necessary and comminute as necessary to provide a uniform, spherical particle size of about 20-50 microns to produce printable carbon powders that melt and sinter under the heated print head or heat beam.

When anisotropic pitch is baked and heat treated, it produces carbon with a high degree of graphitization. Powders made from polyaromatic mesophase pitch are most desirable for additive manufacturing processes, as they are stable under high heat exposure, such as heat beams, and especially important when adding already semi-graphitized reinforcement stabilizers.

Synthetic carbon powders derived from naphthalene or by polyacrylonitrile (PAN) can also be used for 3D printing. Both of these are used extensively in carbon fibers. However, it is difficult to control their melting under normal atmospheric oxygen condition, where these powders may oxidize and rapidly degrade. Therefore, these synthetic mesophase pitches should preferably be used in enclosed 3D printers with inert gases.

PAN powder is derived from free radical polymerization of acrylonitrile (AN) with 1-12% vinyl co-monomers. To synthesize PAN, anionic polymerization is used. PAN thermally oxidizes in air at 230° C. to form an oxidized PAN powder. The powder in this stage can be used for 3D printing by using inert environment. PAN powder can further be carbonized above 1000° C. in inert atmosphere to make carbon. The molecular weight for powder is in the range of 6 to 12 g/mol; with most the most preferred between 9 and 12 g/mol.

Naphthalene mesophase pitch is chemically synthesized and originally used for high-end, stiff carbon fibers. It is prepared from aromatic hydrocarbons with low contaminant levels using hydrogen fluoride and boron trifluoride (HFBF3) as the catalyst. The first procedure heats naphthalene at 80° C. with HFBF3 to give a naphthene-rich pitch followed by heat treatment under vacuum. This produces a spinnable mesophase pitch, which is then slowly stabilized in air. Instead of spinning, it is possible to produce sinterable powders and pellets, which can be used for additive manufacturing.

One embodiment is comprised of a process using a powder product that is a sinterable polyaromatic mesophase pitch powder composition for making carbon objects having a coefficient of thermal expansion less than about 15.×10⁻⁶, comprising carbon particles having a carbon content of at least 65%, a quinoline insolubles content of at least 20% by weight, and average particle size of about 20-150 microns.

Further processing the mesophase powder to a state of graphitization and carbonization increases the melting point to above 3000° C., (it actually sublimes around 3500° C.) which widens the possibilities of metallurgic powder hybridization.

Carbon Powder Reinforcements

Carbon reinforcements, such as nanotubes, short fibers of various materials, whiskers, VGCFs, microbeads, microspheres, graphene, etc. in organic, metal, ceramic, and carbon matrix composites. In carbon-carbon, fibers can bridge cracks, thus leading to greatly enhanced fracture toughness and strain-to-failure. For this reason, carbon-carbon materials are used for high performance applications such as rocket nozzles and missile nose cones and carbon brake discs used in aircraft and sports cars.

The incorporation of nanotubes, short fibers of various materials including whiskers, VGCF, microbeads and microspheres, graphene will further enhance the effective char yield, while also providing a composite reinforcing effect. Since these reinforcements are discontinuous, they are mobile and thus do not obstruct local matrix shrinkage, in contrast to continuously reinforced fibers in carbon-carbon, which lead to matrix cracking. As such these reinforcements can be mixed and imbedded into the carbon powders and molten within the 3D printed object.

Since these reinforcements are discontinuous, they can be added to powders and filaments and therefore are 3D printable, which opens the possibility of low-cost, high strength AM processing. It has been demonstrated that incorporation of 30 weight percent of VGCF in matrix injection molded composite has resulted in an approximate doubling of the tensile strength and quadrupling of the stiffness. 3D printed carbon solids produced including these reinforcement methods can significantly improve the carbon object's quality and practicality.

Even with such careful processing, though, the pure carbon objects may remain a brittle material with low fracture toughness and low strain-to-failure. Incorporating binders, and/or reinforcements or combining with metal powders may substantially mitigates brittleness.

Additive Manufacturing (AM) Processes.

There are three categories of carbon powders used with low temperature 3D printers:

1. Direct Mesophase Carbon Printing

One embodiment of the process to is to 3D print an object made of pure carbon by feeding mesophase powder or pellets directly to the printer. This may be done by way of a hopper and/or a feeder tube that is attached to the printhead. The printhead may be equipped with a pellet extruder, which pushes the material towards the print jet; simultaneously the mesophase material is being heated to between 220° and 400° C., at which stage it becomes viscous and printable. Temperatures vary, depending on the mesophase content of the powder/pellets.

The printed object has approximately the same mesophase content as the initial powder or pellets. Objects with high mesophase content may optionally be further heat-treated by way of carbonization at around 1200° C. and graphitization at around 2600° C. Hereby, the object is subject to shrinkage, as remaining pitch and volatiles evaporate. The objects then become pure graphite, exhibiting known graphite properties such as high thermal conductivity and extreme thermal form stability.

2. Mesophase Carbon—Added to Filaments and Stick Feed

Common low temperature 3D printers, such as used for printing plastic objects, use polymer filament strands or feeder sticks, which are heated and melt at the jet. Producers of these filaments may add between 20% and 30% mesophase carbon to their polymer materials. Producers of feeder sticks may increase the mesophase content to 70%, depending on the polymer material, such as PEEK, Nylon, Acrylonitrile Butadiene Styrene (ABS) or Poly Lactic Acid (PLA). By adding mesophase carbon to these polymers, the plastic objects become stiffer and harder and their surface may become smoother.

3. Mesophase Carbon-Filled Photopolymer Resins

Stereolithographic printers generally use a liquid resin tanks or rollers that spread a thin layer of liquid resin over a bed. The photopolymer resins solidify when subjected to a laser light beam; thus, a printed object is created by a laser beam moving over the resin surface thereby solidifying layer upon layer. Mesophase carbon powders can be blended with these photopolymer resins. For them to fuse, it is preferable that these powders are spherical with very fine particle sizes of 20-30 microns.

B.) High temperature 3D printers suitable for 3D metal-fusion printing.

For carbon powders to be compatible with high temperature metal-melting laser printers, the carbon powders may first be graphitized. Graphite powders can sustain their molecular form above 3000° C. and are actually unmeltable, with negligible thermal expansion. Therefore, these lightweight powders can be compounded or synthesized with most varieties of metal powders and/or ceramic powders with very high melting temperatures, to produce novel material matrix alloys with a large variety of modelled material characteristics. The graphite powders thereby act as a filler material, as they do not melt. As an example, for very high temperature-resistant objects, by adding 50% graphite powders with a density of 2.2 kg to tantalum powders with a density of 16.6 the object density becomes around 9.5. This is a significant weight savings, while the thermal conductivity of the tantalum-graphite matrix increases substantially.

Furthermore, if so desired, spherical mesophase carbon powders with a high mesophase content can be directly mixed with metal powders. During the laser melting process, the mesophase carbon immediately graphitizes and bonds to the surrounding metal and/or ceramic. However, residual pitch and volatiles evaporate, necessitating an additional fume extractor.

1. The Laser Powder Bed fusion process is the most obvious application for the preferred embodiments, which uses graphite and metal and/or ceramic powders as its raw material feedstock. The uniformity of the spherical carbon powders, which are blended and used to build 3D printed metal matrix objects have a critical influence on the final component properties. During the build sequence of an AM object, the powder blend is fed from a hopper close to the processor. A discrete amount of powder blend is spread, either using a rake or roller system across the build chamber to form a thin continuous layer of powder, which is no more than one to two particle diameters. After spreading, it is critical that the layer is homogenous over the entire area of the build chamber, as any degree of inhomogeneity may result in porosity in the absence of powder, or incomplete through-thickness melting by too much powder pooled up in one area. It is therefore desirable that the spherical graphite powder particle sizes match those of the metal and/or ceramic powders. The spread layer is selectively fused using either a laser source, an electron beam or a similar heat beam, which is steered by a sliced three-dimensional (3D) computer aided design (CAD) model. One by one, a layer of carbon/metal matrix powder is spread over the building part until the finished object is created.

The embodiments of the Mesophase Carbon Manufacturing Process of incorporating various carbon, graphite and carbon-hybrid powders in AM offers manufacturers and designers many choices of customized novel materials, with specifications not available until now. It is predictable that many new AM processors and techniques using carbon powders will be developed and refined. The embodiments of the Mesophase Carbon Manufacturing Process do not specifically focus on a particular AM process. It is understood that most all AM processes can be adapted into using a form of carbon powder, carbon hybrid powders and reinforcements mentioned herein.

Carbon powders with lower melting points can be used in AM processors for plastics, while those powders with a very high melting point can be used in metal AM processors. Other popular AM processors that can be used in the embodiments include, digital Light Processing (DLP), Selective laser melting (SLM), Electronic Beam Melting (EBM), Laminated object manufacturing (LOM), Nano Particle Jetting (NPJ), Multifunctional AM (MFAM), Direct Metal Laser Sintering (DMLS), Laser Powder Bed Fusion (LPBF), Single Pass Jetting (SPJ), High Viscosity Jetting (HVJ).

Stereolithography (SLA) utilizes laser technology to cure layer-upon-layer of photopolymer resin. The build occurs in a pool of resin. A laser beam, directed into the pool of resin, traces the cross-section pattern of the model for that particular layer and cures it. During the build cycle, the platform on which the build is positioned, is lowered by a single layer thickness.

Selective Laser Sintering (SLS) is somewhat like SLA technology, but utilizes a higher-powered laser to fuse small powder particles of plastic, metal, ceramic or glass. During the build cycle, the platform on which the build is positioned, is lowered by a single layer thickness, then covered with a single layer of powder with a squeegee or roller. The process repeats until the build or model is completed. Unlike SLA technology, support material is not needed as the build is supported by unsintered material.

Fused Deposition Modeling (FDM) uses thermoplastic (polymer that changes to a liquid upon the application of heat and solidifies to a solid when cooled) materials injected through indexing nozzles onto a platform. The nozzles trace the cross-section pattern for each particular layer with the thermoplastic material hardening prior to the application of the next layer. The process repeats until the build or model is completed.

Multi Jet Modeling (MJM) is similar to an inkjet printer in that a head, capable of shuttling back and forth (3 dimensions-x, y, z) incorporates hundreds of small jets to apply a layer of thermopolymer material, layer-by-layer.

3D Platform (3DP) involves building a model in a container filled with powder. An inkjet printer head shuttles applies a small amount of binder to form a layer. Upon application of the binder, a new layer of powder is swept over the prior layer with the application of more binder. The process repeats until the model is complete. This is the only process that builds in colors.

Single Pass Jetting (SPJ) releases binder material on an exact pass over the metal powder bed, thereby binding the powders into a form. The metal powder objects, held together by the binder, are then further sintered in a furnace, whereby the binder is lost.

Assumption—Specific compositions, methods, or embodiments discussed are intended to be only illustrative of the invention disclosed by this specification. Variations on these compositions, methods, or embodiments are readily apparent to a person of skill in the art based upon the teachings of this specification and are therefore intended to be included as part of the inventions disclosed herein.

1. Individually prepared, by evaporation, distilling, heat treating and/or oxidizing of carbon—containing pitches, follow by oxidizing, comminuting and/or spray drying, to product sinterable carbon powders.

2. Optionally create uniform dryblends of graphitized carbon powders with metal and/or ceramic powders, with various fractions of carbon fibers of various materials, nanotubes, whiskers, spheres, graphene etc. to enhance the carbon properties.

3. Produce net shape carbon—carbon objects with minimal machining by AM (3D printing); then optionally sintering and/or graphitizing and/or carbonizing.

Related AM apparatus, compositions and intricate objects are also taught.

1. The process of manufacturing mesophase carbon articles using additive manufacturing using carbon pitches comprised of mesophase carbon and melting or fusing the manufactured part.

2. The articles produced from the process of manufacturing mesophase carbon articles using additive manufacturing using carbon pitches comprised of mesophase carbon and then melting or fusing the manufactured part.

3. An additive manufacturing precursor compositions comprising of one or more homogeneous carbon particles derived from coal tar, petroleum, naphthalene or polyacrylonitrile, that are capable being: melted, bonded, fused or sintered during an additive manufacturing process to form a solid carbon article; supplemented with thermoplastics, polymers, polyamides, binders or resins, and used in additive manufacturing to form a solid article; carbonized or graphitized; supplemented to metal or ceramic powders and used in additive manufacturing to form a solid article.

4. The additive manufacturing precursor compositions described in claim 3 which, by way of additive manufacturing, individual precursor layers melt, bond, fuse, or sinter and produce in whole or in part a solid carbon article.

5. The additive manufacturing precursor compositions described in claim 3 wherein one or more homogeneous particles are generally mesophase.

6. The additive manufacturing precursor compositions described in claim 5 wherein the precursor is capable of being mixed with pitch.

7. The additive manufacturing precursor compositions described in claim 3 capable of being mixed with polymers, binders or resins to form strands of filaments or feeder sticks or similar plasticized media for feeding 3D printers.

8. The additive manufacturing precursor compositions described in claim 3 that are mixed with liquid resin.

9. The additive manufacturing precursor compositions described in claim 3 that are blended with short carbon fibers, VGCF, nanotubes, whiskers, spheres or graphene or a combination thereof to form additive manufactured carbon articles.

10. The additive manufacturing precursor compositions described in claim 3 wherein the solid article can be carbonized or graphitized via heat treatment.

11. The additive manufacturing precursor compositions described in claim 3 wherein the carbon precursor is supplemented with graphite powders.

12. The additive manufacturing precursor compositions described in claim 3 whereas the particles are carbonized or graphitized, thereby become unmeltable, and are compounded with metal or ceramic matrix powders, or a combination thereof, which can be additive manufactured in high temperature environment 3D printers to form a solid hybrid matrix article.

13. The additive manufacturing precursor compositions described in claim 3 mixed with metal or ceramic matrix powders and which are additive manufactured using binders, and which are further heat treated or sintered form a solid article, whereby the binders evaporate.
